(19) United States
(12) Patent Application Publication
(10) Pub. No.: US 2009/0195564 A1
(43) Pub. Date: Aug. 6, 2009

(54) Driving method in liquid crystal display

(75) Inventors: Fang-Yi Jen, Hsin-Chu (TW); Ching-Huan Lin, Hsin-Chu (TW); Chung-Hsiang Chiu, Hsin-Chu (TW); Chih-Ming Chang, Hsin-Chu (TW)

Correspondence Address: RABIN & Berdo, PC, 1101 14TH STREET, NW, SUITE 500, WASHINGTON, DC, 20005, US

(73) Assignee: AU OPTRONICS CORP., Hsin-Chu (TW)

(21) Appl. No.: 12/216,105

(22) Filed: Jun. 30, 2008

(30) Foreign Application Priority Data
Feb. 4, 2008 (TW) 097104244

(51) Int. Cl. G09G 5/10; G09G 5/00

(52) U.S. Cl. 345/690; 345/204

(57) ABSTRACT

A driving method in a liquid crystal display comprises the steps of: (a) receiving a first signal in a first time period; (b) comparing the first signal with a predetermined signal; (c) outputting the predetermined signal when a value of the first signal being smaller than or equal to a value of the predetermined signal; (d) transforming the predetermined signal into a driving voltage to drive a pixel; and (e) receiving a second signal and generating an overdriving voltage according to the predetermined signal and the second signal to drive the pixel in a second time period.

### RELATED APPLICATIONS

This application claims priority to Taiwan Patent Application Serial Number 97104244, filed Feb. 4, 2008, which is herein incorporated by reference.

### BACKGROUND

1. Field of Invention

The present invention relates to a driving method in a display. More particularly, the present invention relates to a driving method in a liquid crystal display.

2. Description of Related Art

In a conventional liquid crystal display, an overdriving voltage is usually applied to pixels thereby driving liquid crystal molecules and speeding the response time thereof, such that image frames are able to change quickly.

FIG. 1 illustrates a changing process of image frames in a stable state. As shown in FIG. 1, after an initial image frame represented by the gray scale value of 0 stops for several frame time periods (e.g. 500-1000 milliseconds), then an overdriving voltage corresponding to a gray scale value of 250 drives the liquid crystal molecules, and the image frame changes from the initial image frame represented by the gray scale value of 0 to a target image frame represented by the gray scale value of 150.

However, when the liquid crystal display shows images, the shown images usually change in a frame-by-frame manner. Thus, the change of the image frames is very fast. On the other hand, even if the change of the image frames is not fast, the frame time period for which each image frame stops is still very short. Therefore, whenever driven by the overdriving voltage, the liquid crystal molecules cannot rotate to a predetermined location at the right moment, such that the image frames cannot be display correctly, as a result of the image frames changing too fast. FIG. 2 illustrates a conventional changing process of image frames. As shown in FIG. 2, a driving voltage first drives the liquid crystal molecules such that the image frame changes from the image frame represented by the gray scale value of 150 to the image frame represented by the gray scale value of 0. Then, an overdriving voltage corresponding to a gray scale value of 250 drives the liquid crystal molecules such that the image frame changes from the image frame represented by the gray scale value of 0 to the image frame represented by the gray scale value of 150. However, the image frame changes to the image frame represented by the gray scale value of 0 and temporarily stops for only two frame time periods, such that the liquid crystal molecules cannot respond immediately, so the image frame represented by the gray scale value of 0 cannot be displayed as expected, and an overshoot happens accordingly when the overdriving voltage is applied, to cause streaks on the image frame shown on the liquid crystal display.

### SUMMARY

In accordance with one embodiment of the present invention, a driving method in a liquid crystal display is provided. The driving method comprises the steps of: (a) receiving a first signal in a first time period; (b) comparing the first signal with a predetermined signal; (c) outputting the predetermined signal when a value of the first signal being smaller than or equal to a value of the predetermined signal; (d) transforming the predetermined signal into a driving voltage to drive a pixel; and (e) receiving a second signal and generating an overdriving voltage according to the predetermined signal and the second signal to drive the pixel in a second time period.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference to the accompanying drawings as follows:

FIG. 1 illustrates a changing process of image frames in a stable state;

FIG. 2 illustrates a conventional changing process of image frames;

FIG. 3 illustrates a flow chart of a driving method in a liquid crystal display according to one embodiment of the present invention;

FIG. 4 illustrates a changing process of the image frames when implementing the driving method of the embodiment of the present invention;

FIG. 5 illustrates a conventional lookup table; and

FIG. 6 illustrates a lookup table according to one embodiment of the present invention.

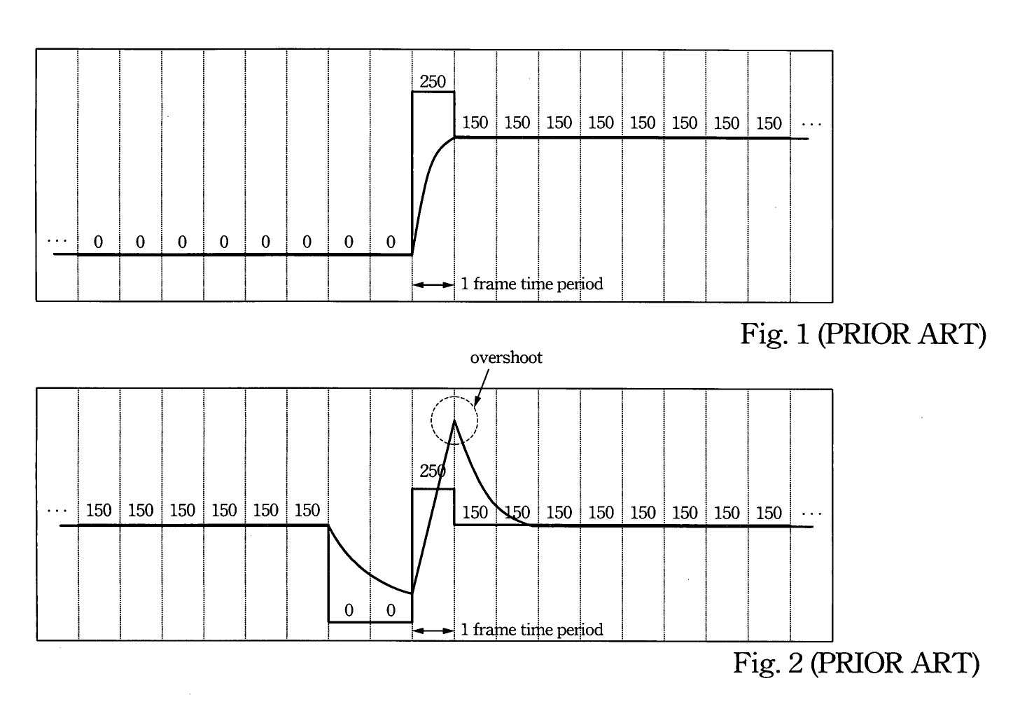

### DESCRIPTION OF THE PREFERRED EMBODIMENTS

In the following detailed description, the embodiments of the present invention have been shown and described. As will be realized, the invention is capable of modification in various respects, all without departing from the invention. Accordingly, the drawings and description are to be regarded as illustrative in nature, and not restrictive.

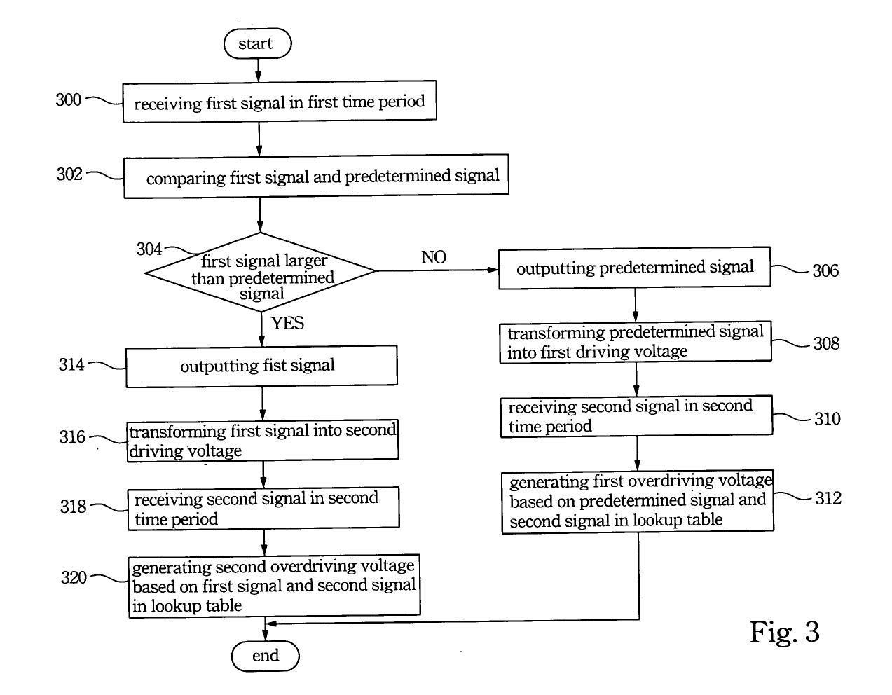

FIG. 3 illustrates a flow chart of a driving method in a liquid crystal display according to one embodiment of the present invention. First, a first signal is received in a first time period (Step 300), in which the first signal represents a gray scale value of an image being input into the liquid crystal display. Then, the first signal received in the first time period is compared to a predetermined signal (Step 302), in which the predetermined signal represents another gray scale value and is determined through a set of experiments. Further, a comparator can carry out the foregoing comparing step.

After that, whether the value of the first signal is larger than the value of the predetermined signal is determined (Step 304). When the value of the first signal is smaller than or equal to the value of the predetermined signal, the predetermined signal is output (Step 306). Then, the predetermined signal is transformed into a first driving voltage to drive a pixel (Step 308). Thereafter, a second signal is received in a second time period (Step 310), in which the second time period is closely adjacent to the first time period and appears after the first time period. The second signal is the gray scale value corresponding to the predetermined signal in a lookup table (LUT), and the gray scale value represented by the second signal is larger than the gray scale value represented by the predetermined signal. Then, an overdriving voltage is generated in the second time period based on the predetermined signal and the second signal with reference to the lookup table (Step 312), so as to drive the pixel and reduce the response time of the liquid crystal molecules.

On the other hand, when the value of the first signal is larger than the value of the predetermined signal, the first signal is output (Step 314). Then, the first signal is transformed into a second driving voltage to drive the pixel (Step 316). Thereafter, the second signal is received in the second time period (Step 318), in which the second signal is the gray scale value corresponding to the first signal in the lookup table. Then, a second overdriving voltage is generated in the second time period based on the first signal and the second signal with reference to the lookup table (Step 320), so as to drive the pixel and reduce the response time of the liquid crystal molecules.

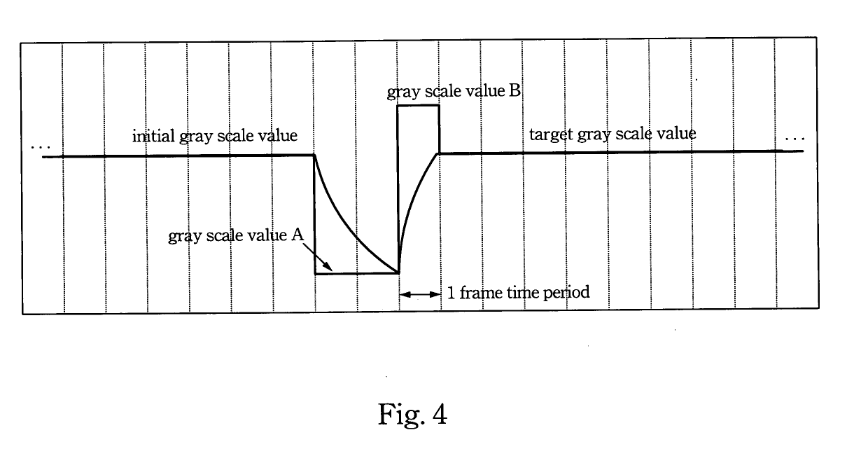

FIG. 4 illustrates a changing process of the image frames when implementing the driving method of the embodiment of the present invention. As shown in FIG. 4, when the driving method of the embodiment of the present invention is implemented, the initial image frame can change during a shorter time period to the next image frame, i.e. the image frame represented by the gray scale value of A, to be stable. In addition, no overshoot occurs when the image frame represented by the gray scale value of A changes to the image frame represented by the target gray scale value. In the meantime, when driven by the overdriving voltage corresponding to the gray scale value of B, the image frame represented by the gray scale value of A can change smoothly to the image frame represented by the target gray scale value.

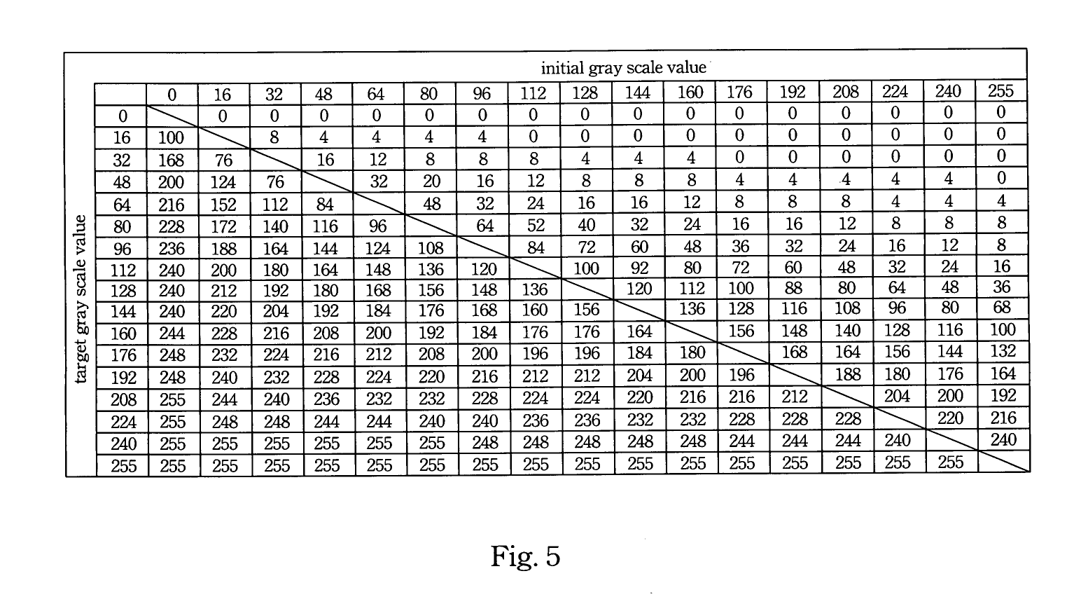

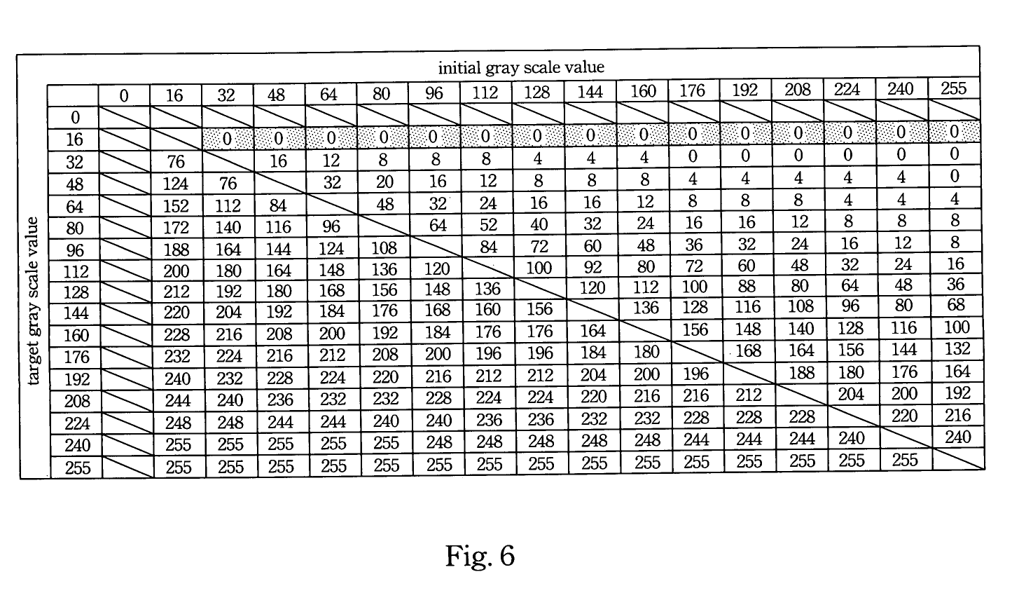

Furthermore, when the foregoing driving method is implemented to drive the pixel, the lookup table should be modified accordingly. FIG. 5 illustrates a conventional lookup table. FIG. 6 illustrates a lookup table according to one embodiment of the present invention. Refer to FIG. 5 and FIG. 6, and take for example the gray scale value of 16 as a predetermined gray scale value. As described above, all gray scale values smaller than or equal to the gray scale value of 16 are replaced with the gray scale value of 16, so the first column of the lookup table in FIG. 6 can be omitted; that is, there will be no change starting from the gray scale value of 0. In addition, all gray scale values smaller than the gray scale value of 16 are replaced with the gray scale value of 16, so the first row of the lookup table can be omitted as well; that is, there will be no change to the gray scale value of 0. Other than that, any image frame represented by the initial gray scale value can change to the target image frame represented by the gray scale value of 16, by applying the overdriving voltage corresponding to the gray scale value of 0.

For the foregoing embodiments of the present invention, the driving method in the liquid crystal display can be used, during the change of the image frames, to effectively reduce the streaks and the distortion on the image frame, such that users feel more comfortable when they watch the image frames.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A method for driving a liquid crystal display, comprising:
(a) receiving a first signal in a first time period;
(b) comparing the first signal with a predetermined signal;
(c) outputting the predetermined signal when a value of the first signal being smaller than or equal to a value of the predetermined signal;
(d) transforming the predetermined signal into a driving voltage to drive a pixel; and
(e) receiving a second signal and generating an overdriving voltage according to the predetermined signal and the second signal to drive the pixel in a second time period.

2. The method of claim 1, further comprising:
outputting the first signal when the value of the first signal received in the first time period being larger than the value of the predetermined signal; and
transforming the first signal into a second driving voltage to drive the pixel.

3. The method of claim 2, further comprising:
generating a second overdriving voltage according to the first signal and the second signal to drive the pixel in the second time period.

4. The method of claim 1, wherein step (b) is carried out by a comparator.

5. The method of claim 1, wherein the second time period is closely adjacent to the first time period and appears after the first time period.

6. The method of claim 1, wherein the first signal, the second signal and the predetermined signal are gray scale values.

7. The method of claim 1, wherein the generated overdriving voltage is obtained based on the predetermined signal and the second signal with reference to a lookup table.

8. The method of claim 1, wherein a value of the second signal is larger than the value of the predetermined signal in the second time period.
